(19) United States
(12) Patent Application Publication
(10) Pub. No.: US 2003/0085199 A1
(43) Pub. Date: May 8, 2003

(54) Method for manufacturing catalytic oxide anode using high temperature sintering

(75) Inventors: Kwang-Wook Kim, Daejeon-Si (KR); Eil-Hee Lee, Daejeon-Si (KR); Jung-Sik Kim, Daejeon-Si (KR); Ki-Ha Shin, Cheongju-Si (KR); Boong-Ik Jung, Cheongju-Si (KR)

Correspondence Address: ARENT FOX KINTNER PLOTKIN & KAHN, PLLC, Suite 600, 1050 Connecticut Avenue, N.W., Washington, DC, 20036-5339, US

(73) Assignee: Korea Atomic Energy Research Institute & Technology Winners Co., Ltd.

(21) Appl. No.: 10/022,357

(22) Filed: Dec. 20, 2001

(30) Foreign Application Priority Data
Nov. 8, 2001 (KR) 01-69402

(51) Int. Cl. B44C 1/22; C03C 25/68

(52) U.S. Cl. 216/103; 216/100

(57) ABSTRACT

Disclosed is a method for manufacturing a catalytic oxide anode using high temperature sintering, which can increase a decomposition efficiency of an organic substance by improving a performance of the catalytic oxide anode (Ru oxide anode, Ir oxide anode) used in a water treatment, and in particular, to a method for manufacturing a catalytic oxide anode, in which the oxide anode is sintered at 600° C. or higher, and a TiO₂-screening layer is formed between a titanium base metal and a catalytic oxide layer to prevent a lowering of the oxide anode activity owing to an oxidation of the titanium base metal caused by sintering the oxide anode at high temperature and a solid diffusion of an oxide into an anode surface. The method for manufacturing the catalytic oxide anode is characterized in that the titanium base metal is etched with hydrochloric acid, followed by being coated with a solution of RuCl₃ or chlorides of IrO₃ in hydrochloric acid according to a brushing or dipping method, and then the resulting material is dried at 60° C. for 10 min, thermally treated at 250 to 350° C. for 10 min, and finally sintered at 600 to 700° C. for 1 to 2 hours.

### BACKGROUND OF THE INVENTION

1. Field of the Invention

The present invention relates, in general, to a method for manufacturing a catalytic oxide anode using high temperature sintering, which can increase a decomposition efficiency of an organic substance or a production of hypochlorous acid by improving a performance of the catalytic oxide anode (Ru oxide anode, Ir oxide anode) used in a water treatment, and in particular, to a method for manufacturing a catalytic oxide anode, in which the oxide anode is sintered at 600° C. or higher, and a TiO₂-screening layer is formed between a titanium base metal and a catalytic oxide layer to prevent a lowering of the oxide anode activity owing to an oxidation of the titanium base metal caused by sintering the oxide anode at high temperature and a solid diffusion of an oxide into an anode surface.

2. Description of the Prior Art

Generally, when a catalytic oxide anode used in a water treatment process is manufactured, decomposition performance of an organic substance by the oxide anode as well as physical and electrochemical properties of the oxide anode should be estimated.

An electrochemical water treatment process using the catalytic oxide anode used in a decomposition of a non-degradable organic substance, sterilization, and bleaching of waste water has advantages of a low temperature and a remote control process, and production of oxidants without chemical additives generating secondary waste. The oxidant is active hydroxyl radicals OH⁻ produced during a production of oxygen during an electrolysis reaction of water, or chloric acid ions [hypochlorous acid OCl⁻, chlorous acid OCl₂⁻, chloric acid OCl₃⁻, perchloric acid OCl₄⁻] owing to a production of chlorine.

The catalytic oxide anode developed in the 1970's is referred as DSA (Dimensionally Stable Anode), and requires a relatively low overvoltage to produce oxygen. Poisonous organics on the oxide anode surface are oxidized by various highly reactive oxygen species produced from the oxide anode surface. Furthermore, the oxide anode can convert organics in waste water into carbon dioxide and water to incinerate the organics, and also be used for a long time because the oxide anode surface is made of ceramics, in comparison with other metal electrodes. Accordingly, the oxide anode can be applied to various water treatment applications such as a decomposition of a non-degradable organic substance, sterilization and bleaching of waste water.

A representative catalytic oxide anode is RuO₂/Ti or IrO₂/Ti, which is a catalytic oxide having a rutile structure.

Generally, when a catalytic oxide anode is manufactured, it is necessary to measure electrochemical properties such as a voltammetric charge capacity (Q) indicating a degree of activity of the oxide anode or a tafel slope in generation of oxygen or chlorine; and physical properties such as a resistance of the oxide anode surface. Variables affecting electrochemical and physical properties of the oxide anode include an etching method of titanium base metal, a coating method of metal chloride which is coated on the base metal, the number of a coating process, and a sintering temperature. Among the above variables, the sintering temperature is the most important, and it has been defined within a range from 400 to 550° C. during the manufacture of RuO₂ or IrO₂ anodes.

The sintering temperature is defined within a range from 400 to 550° C. so that the oxide anode has a sufficient anode activity, and low resistance of its surface when RuCl₃ or IrCl₃ used as a coating material of the oxide anode is converted to RuO₂ or IrO₂.

However, when the sintering temperature is higher than 550° C., the resistance of the oxide anode surface is rapidly increased and the oxide anode activity is reduced due to an oxidation of the titanium base metal.

As shown in FIGS. 1 and 2, where an electric charge Q, of RuO₂ or IrO₂ anodes, and a resistance of RuO₂ or IrO₂ anodes, respectively, are measured within a range of +0.3 to +1.03 V at a scanning rate of 40 mV/sec, with regard to sintering temperatures of the anodes, it is apparent that the resistance of the oxide anode surface is rapidly increased and the oxide anode activity is reduced when the sintering temperature is higher than 550° C., and so the sintering temperature of the oxide anode cannot be more than 600° C. in view of electrochemical and physical properties. On the other hand, when the temperature is less than 400° C., the oxide anode surface is not fully converted to an oxide.

The conventional RuO₂ or IrO₂ anodes sintered at 400 to 550° C. have good electrochemical properties, but do not optimally decompose organic substances. To manufacture an oxide anode with optimum performance, therefore, decomposition efficiency of organic substances by the oxide anode, as well as physical and electrochemical properties of the oxide anode, should be estimated.

Thus far, there have been disclosed many prior arts for catalytic oxide anodes. However, the present invention is different from prior arts in various aspects. For example, the present invention differs from Korean Patent Publication Nos. 1982-1344, 1995-26819, 1997-10672, 2000-40399, 2000-13786, 2001-28158 in manufacturing method and sintering temperature. Being directed to Sn-coating of transition metal oxides. U.S. Pat. Nos. 5,756,207, and 5,705,265 are different from the present invention in object, manufacturing method, and sintering temperature. A difference between the present invention and U.S. Pat. No. 4,444,642 which describes a dimensionally stable coated electrode for electrolytic process, comprising a protective oxide layer on valve metal base, and process for manufacturing the same, in which the electrode is DSA, i.e. PbO₂, MgO₂, resides in sintering temperature. A related prior art can be found in U.S. Pat. No. 4,426,263 which disclose a method and electrocatalyst for making chlorine dioxide, in which the catalytic anode is Ru—Rh, Ru—Rh—Pb, Ru—Pb, Ir—Rh, and Ir—Pt. However, nowhere is mentioned a manufacturing method of electrodes. U.S. Pat. No. 6,103,299, which discloses a method for preparing an electrode for electrolytic processes, in which an oxide comprises Ti, Ta, and Nb chlorides, is related to, but apparently different from the present invention.

Furthermore, according to C. Comninellis, G. P. Vercesi [J. Appl. Electrochem., Vol. 21, 335(1991)], an oxide anode should be sintered at 560° C. or lower because an oxide film causes a problem of reduced conductivity when the oxide anode is sintered at 560° C. or higher. And also, there are disclosed oxide anodes sintered at 600° C. or lower according to J. M. Eugene et al. [J. Electrochem. Soc., Vol. 136(9), 2596(1989)]. In addition, when the RuO₂ or IrO₂ oxide anode is manufactured, the oxide anode is sintered at 600° C. or lower according to S. Trasatti [Electrochimica Acta, Vol. 29, 1504(1984)], C. Comniellis [Electrochmica Acta, Vol. 39, 1857(1994)], J. F. C. Boodts. S. Trasatti [J. Electrochem. Soc., Vol. 137, 3784(1990)]. A. D. Battisti, G. Lodi, M. Cappadonia, G. Bataglin, R. Kotz [J. Electrochem., Soc., Vol. 136(9), 2596(1989)], J. Krysa, L. Kule, R. Mraz, I. Rousar [J. Appl. Electrochem., Vol. 26, 1996(1996)]. L. D. Silva, V. A. Alves, M. A. P. da Silva, S. Trasatti. J. F. C. Boots [Can. J. Chem., Vol. 75, 1483(1997)]. R. Kotz, H. J. Lewerenz, S. Stucki [J. Electrochem. Soc., Vol. 130, 825(1983)], A. S. Pilla, E. O. Cobo, M. M. Duarte, D. R. Salinas [J. Appl. Electrochem., Vol. 27, 1283(1997)]. C. Comninellis, G. P. Vercesi [J. Appl. Electrochem., Vol. 21, 335(1991)], T. A. F. Lassa; I, L. O. S. Bulhoes, L. M. C. Abeid, J. F. C. Boodts [J. Electrochem. Soc., Vol. 144(10), 3348(1997)].

### SUMMARY OF THE INVENTION

It is therefore an object of the present invention to avoid disadvantages of a conventional catalytic oxide anode, and to provide a method for manufacturing a catalytic oxide anode sintered at high temperature, which can increase a decomposition efficiency of an organic substance by the oxide anode and a production rate of active chloric acid ions with about the same electric power consumption rate as the conventional anode in water treatment applications using electrolysis, such as, sterilization and bleaching of waste water, and oxidization of organic substances.

To accomplish the above object, the present invention provides a method for manufacturing a catalytic oxide anode, in which the catalytic oxide anode is sintered at 600° C. or higher, and a TiO₂-screening layer, i.e. a valve metal oxide layer for suppressing a lowering of the oxide anode activity owing to an oxidation of the titanium base metal caused by sintering the oxide anode at high temperature and a solid diffusion of an oxide into an anode surface, is formed between a titanium base metal and an oxide layer of the oxide anode surface, with estimation of decomposition properties of an organic substance by the oxide anode as well as physical and electrochemical properties of the oxide anode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a graph illustrating the effect of a varying sintering temperature on an active electric charge in conventional RuO₂ and IrO₂ oxide anode surfaces;

FIG. 2 is a graph illustrating the effect of a varying sintering temperature on a resistance of conventional RuO₂ and IrO₂ oxide anode surfaces;

FIG. 3 is a graph illustrating the effect of a varying sintering temperature on a decomposition rate of 4 CP by RuO₂ and IrO₂ oxide anodes;

FIG. 4 is a graph illustrating the effect of a varying sintering temperature on a decomposition rate of 4 CP by RuO₂ and IrO₂ oxide anodes with TiO₂-screening layer;

FIG. 5 is a graph illustrating the effect of a TiO₂-screening layer on the relative concentrations of titanium, iridium, and oxygen measured by AES (Auger Electron Spectroscopy: VG Microlab 300R) in the surface of IrO₂ anode;

FIG. 6 is a graph illustrating a reduction rate of chlorine ions in an aqueous solution and a production rate of active chloric acid when RuO₂ anode of the present invention is used;

FIG. 7 is a graph illustrating a reduction rate of chlorine ions in an aqueous solution and a production rate of active chloric acid when IrO₂ anode of the present invention is used.

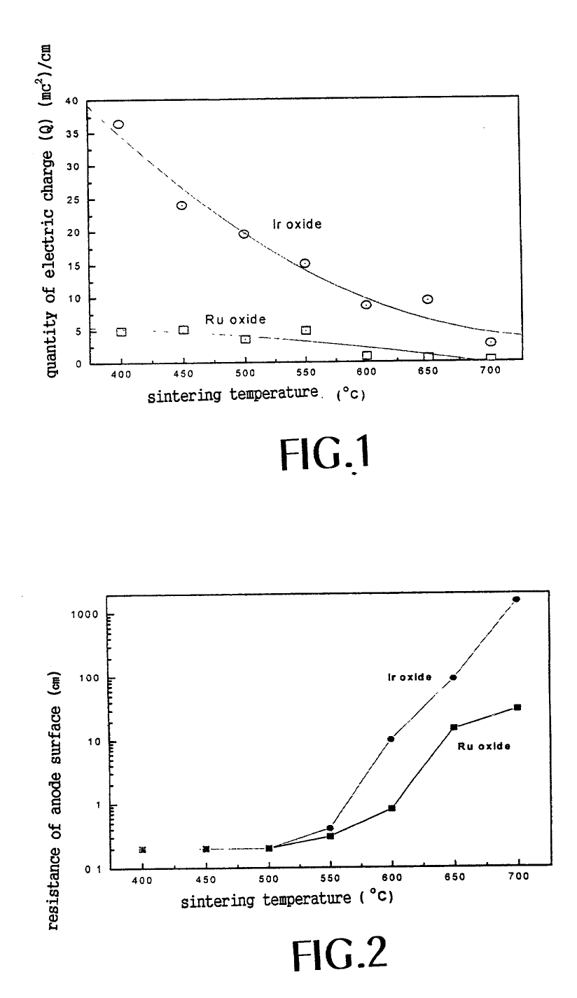

### DETAILED DESCRIPTION OF THE INVENTION

The present invention provides a method for manufacturing a catalytic oxide anode of RuO₂ or IrO₂ using high temperature sintering, wherein a titanium base metal is etched with hydrochloric acid, followed by being coated with a solution of RuCl₃ or chlorides of IrO₃ in hydrochloric acid according to a brushing or dipping method, and then the resulting material is dried at 60° C. for 10 min, thermally treated at 250 to 350° C. for 10 min, and finally sintered at 600 to 700° C. for 1 to 2 hours.

Furthermore, the present invention provides a method for manufacturing a catalytic oxide anode, wherein a TiO₂-screening layer is formed between a titanium support and a surface of the oxide anode, coated with a solution of RuCl₃ or chlorides of IrO₃ in hydrochloric acid according to a brushing or dipping method, dried at 60° C. for 10 min, thermally treated at 250 to 350° C. for 10 min, and finally sintered at 600 to 700° C. for 1 to 2 hours, the TiO₂-screening layer serving as an valve metal oxide for preventing the activity of the anode from being lowered owing to the oxidation of a titanium base metal caused upon sintering of the anode at high temperature and the solid diffusion of an oxide into the anode surface, the valve metal oxide being selected from the group consisting of TiO₂, SnO₂, RuO₂, and IrO₂ sintered at 450 to 550° C.

In more detail, the titanium base metal is cleaned with a cleaning solution in an ultrasonic cleaner at 80° C. for 30 min, and then degreased and cleaned with a solvent, i.e. trichloroethylene for 24 hours or more, followed by being etched with 10 to 35% HCl at 40 to 60° C. for a certain period of time. After being rinsed with an ultra pure water, the etched titanium base metal is coated with 0.2 M RuCl₃ or a solution of 1:1 IrO₃:hydrochloric acid (v/v) by brushing or dipping.

After that, the resulting titanium metal is dried at 60° C. for 10 min and then sintered at 250 to 350° C. for 10 min, repeatedly, to form the desired number of coats, followed by being sintered at 600 to 700° C. for 1 to 2 hours, thereby the catalytic oxide anode having an improved performance is manufactured. To prevent a lowering of the anode activity owing to an oxidation of a titanium base metal caused by sintering the anode at high temperature and a solid diffusion of an oxide into an anode surface, a valve metal oxide layer, i.e. TiO₂-screening layer, is formed between the titanium base metal and an oxide layer of the anode surface.

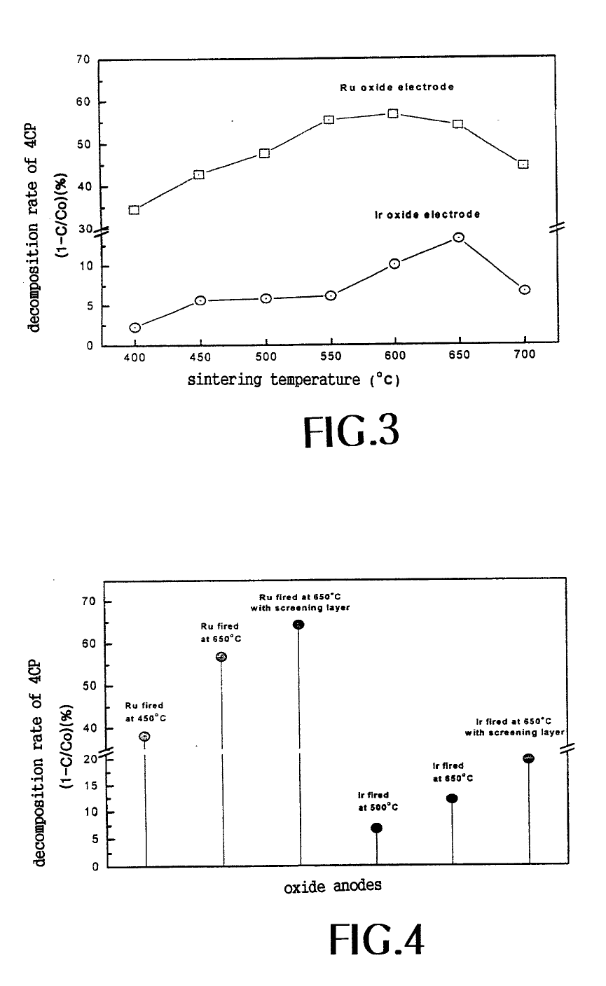

According to the present invention, a decomposition efficiency of organic substances by the oxide anode is increased by 50 to 100% because the oxide anode is manufactured at 600 to 700° C., which is higher than a conventional sintering temperature range for manufacturing RuO₂ or IrO₂ anode, i.e. 400 to 550° C., by 100° C. or higher, thereby the performance of the catalytic oxide anode is improved. With reference to FIG. 3 illustrating the effect of a varying sintering temperature on a decomposition rate of 4 CP by RuO₂ and IrO₂ oxide anodes, the organic substance, i.e. 4-chlorophenol, is most actively decomposed at 600 to 700° C., not at 400 to 550° C.

As described above, the reason why the decomposition efficiency of the organic substance is increased is that active sites producing reactive oxygen species or chlorine are insufficient in number because metallic chlorides in a coating solution are not fully converted to metallic oxides when the oxide anode is sintered at the conventional sintering temperature, and reactive oxygen species or chlorine with a higher reactivity are produced from the surface of the oxide anode sintered at higher temperature than the conventional sintering temperature to more actively decompose organic substances.

According to the present invention, however, there is a problem that an activity of the oxide anode is reduced and a resistance of the oxide anode surface is increased because the titanium base metal is oxidized and an oxide of titanium is diffused into the surface layer of the oxide anode, i.e. Ir or Ru oxide layer, when the oxide anode is sintered at 600° C. or higher. To avoid the above problem, it is necessary to form a different metal oxide layer (TiO₂, SnO₂, RuO₂, IrO₂) sintered at 450 to 550° C., i.e. the TiO₂-screening layer for suppressing a production of TiO₂ owing to an oxidation of the titanium base metal and a solid diffusion, between the titanium base metal and the oxide layer of the oxide anode surface.

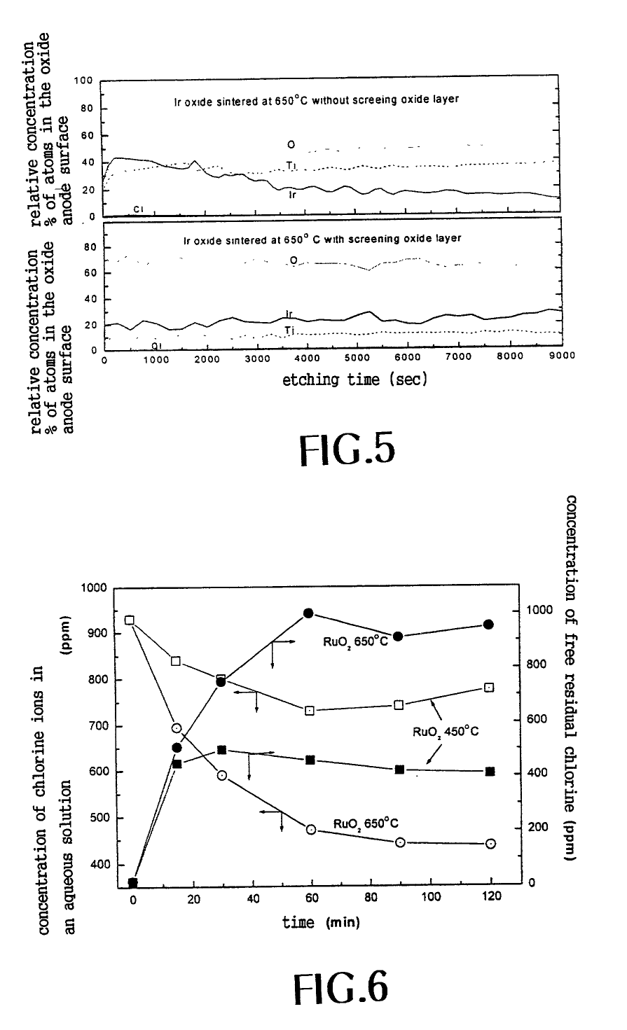

With reference to FIG. 4, the oxide anode with the TiO₂-screening layer sintered at 650° C. increases a decomposition rate of 4 CP.

In comparison with an oxide anode sintered at the conventional sintering temperature, the oxide anode with the TiO₂-screening layer sintered at 600° C. or higher improves the decomposition rate of the organic substance. For example, the decomposition rate is increased by 70% for RuO₂ anode, and by 250% or more for IrO₂ anode.

Referring to FIG. 5, there is illustrated the effect of the TiO₂-screening layer on the relative concentrations of titanium, iridium, and oxygen measured by AES in the surface of IrO₂ anode. The extent to which the TiO₂-screening layer suppresses solid diffusion of TiO₂ into the IrO₂ anode surface, owing to an oxidation of the titanium base metal, is measured by AES.

When the Ir oxide anode is sintered at 650° C. without the TiO₂-screening layer, a concentration of titanium around an oxide layer of the oxide anode surface is higher than that of iridium because the titanium base metal is oxidized and TiO₂ is fully diffused into the surface of the oxide anode. On the other hand, when the Ir oxide anode is sintered at 650° C. with the TiO₂-screening layer, the concentration of iridium is higher than that of titanium because the diffusion is suppressed. These phenomena are equally true of RuO₂ anode.

With reference to FIG. 2, a resistance of iridium oxide surface sintered at 650° C. without the TiO₂-screening layer is about 100 Ωcm, but iridium oxide sintered at 65° C. with the TiO₂-screening layer has a reduced surface resistance of 10 Ωcm or less. As apparent from the above description, it can be seen that a production of TiO₂ owing to an oxidation of the titanium base metal largely affects the resistance of the oxide anode surface, and the TiO₂-screening layer greatly reduces an amount of TiO₂ existing on the anode surface sintered at high temperature.

When the sintering temperature of RuO₂ or IrO₂ anode is increased, an electric power consumption rate of RuO₂ or IrO₂ anode sintered at 650° C. is not greatly increased during the decomposition of organic substance, although the resistance of the oxide anode surface is greatly increased from 550° C., as shown in FIG. 2, but the electric power consumption rate of the RuO₂ or IrO₂ oxide anode is almost identical to that of the oxide anode sintered at 400 to 55° C.—the difference is only 2 to 3%.

As described above, the reason why the electric power consumption rates between two anodes sintered at different temperatures are almost identical is that a physical resistance of the catalytic oxide anode surface does not greatly affect an electric conductivity of a real anode surface, due to interaction between ions in a real solution during the electrolysis reaction.

Accordingly, the oxide anode with the TiO₂-screening layer of the present invention greatly increases a decomposition rate of an organic substance without additional electric power consumption.

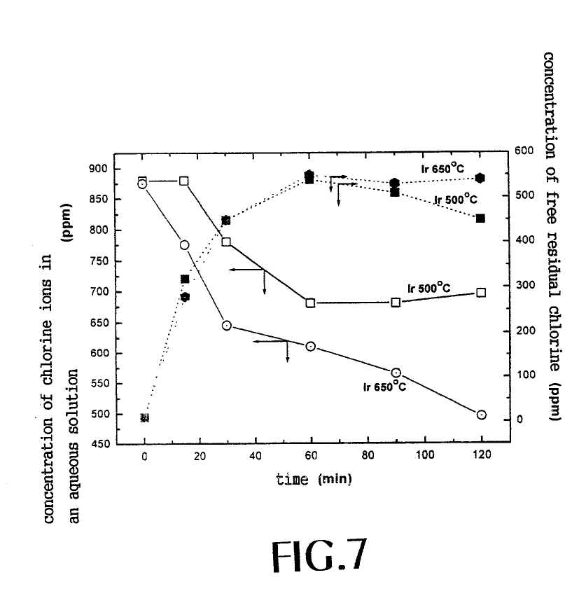

Referring to FIGS. 6 and 7, a concentration of free residual chlorine (Cl₂, HOCl, OCl⁻) is plotted to estimate a production rate of chloric acid ions having a high oxidizing power and bactericidal activity, by IrO₂ or RuO₂ anode sintered at high temperature. As apparent from the result shown in FIGS. 6 and 7, it can be seen that a reduction rate of chlorine ion in a solution and a production rate of chloric acid ions by the oxide anode according to the present invention are faster in comparison with the conventional oxide anode.

As described above, the present invention has advantages in that a catalytic oxide anode such as RuO₂ or IrO₂ anode increases a decomposition efficiency of organic substances and a production rate of active chloric acid ions without additional electric power consumption in water treatment applications using an electrolysis reaction, such as sterilization and bleaching of waste water, and oxidization of an organic substance.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

What is claimed is:

1. A method for manufacturing a catalytic oxide anode of RuO₂ or IrO₂ using high temperature sintering, wherein a titanium base metal is etched with hydrochloric acid, followed by being coated with a solution of RuCl₃ or chlorides of IrO₃ in hydrochloric acid according to a brushing or dipping method, and then the resulting material is dried at 60° C. for 10 min, thermally treated at 250 to 350° C. for 10 min, and finally sintered at 600 to 700° C. for 1 to 2 hours.

2. A method for manufacturing a catalytic oxide anode using high temperature sintering, wherein a TiO₂-screening layer is formed between a titanium support and a surface of the oxide anode, coated with a solution of RuCl₃ or chlorides of IrO₃ in hydrochloric acid according to a brushing or dipping method, dried at 60° C. for 10 min, thermally treated at 250 to 350° C. for 10 min, and finally sintered at 600 to 700° C. for 1 to 2 hours, said TiO₂-screening layer serving as an valve metal oxide for preventing the activity of the anode from being lowered owing to the oxidation of a titanium base metal caused upon sintering of the anode at high temperature and the solid diffusion of an oxide into the anode surface, said valve metal oxide being selected from the group consisting of TiO₂, SnO₂, RuO₂, and IrO₂ sintered at 450 to 550° C.
